(19) United States
(12) Patent Application Publication
(10) Pub. No.: US 2016/0124564 A1
(43) Pub. Date: May 5, 2016

(54) ELECTRONIC DEVICE AND METHOD FOR AUTOMATICALLY SWITCHING INPUT MODES OF ELECTRONIC DEVICE

(71) Applicant: FIH (HONG KONG) LIMITED, Kowloon (HK)

(72) Inventor: YU-TING HUANG, New Taipei (TW)

(21) Appl. No.: 14/752,343

(22) Filed: Jun. 26, 2015

(30) Foreign Application Priority Data
Oct. 29, 2014 (TW) 103137513

(51) Int. Cl. G06F 3/041; G06F 3/16

(52) U.S. Cl. CPC G06F 3/0416; G06F 3/167

(57) ABSTRACT

In a method for switching input modes of an electronic device, the electronic device includes a text input interface, a touch screen, and a voice input device. The method detects a current input mode used by the electronic device when the text input interface is activated. The current input mode is automatically switched to a voice input mode for processing a voice input operation when the voice input operation is performed on a voice input device of the electronic device. The current input mode is automatically switched to a handwriting mode for processing a handwriting operation when the handwriting operation is performed on a touch screen of the electronic device.

### CROSS-REFERENCE TO RELATED APPLICATIONS

This application claims priority to Taiwanese Patent Application No. 103137513 filed on Oct. 29, 2014, the contents of which are incorporated by reference herein.

### FIELD

Embodiments of the subject matter herein generally relate to point cloud processing technology, and particularly to an electronic device and a method for automatically switching input modes during inputting information to the electronic device.

### BACKGROUND

Electronic devices may receive various commands and texts from a user with additional input components. For example, an electronic device may receive texts easily from a user with a keyboard and may be equipped with an additional button for changing an input mode to receive various inputs. Smart phones can have both a touch screen and a physical keyboard. In addition, these electronic devices can have cameras and microphones integrated into them for more specialized application inputs. Therefore, there is a need to provide an input mode switching method for these electronic devices.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of one example embodiment of a hardware environment for executing an input mode switching system in an electronic device.

FIG. 2 illustrates a flowchart of an example embodiment of a method for automatically switching a current input mode of the electronic device to a voice input mode when a voice input operation is performed on the electronic device.

FIG. 3 illustrates a flowchart of an example embodiment of a method for automatically switching a current input mode of the electronic device to a handwriting input mode when a handwriting operation performed on the electronic device.

FIG. 4 is diagram illustrating one embodiment of automatically switching an current input mode of the electronic device between a handwriting input mode and a voice input mode.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like.

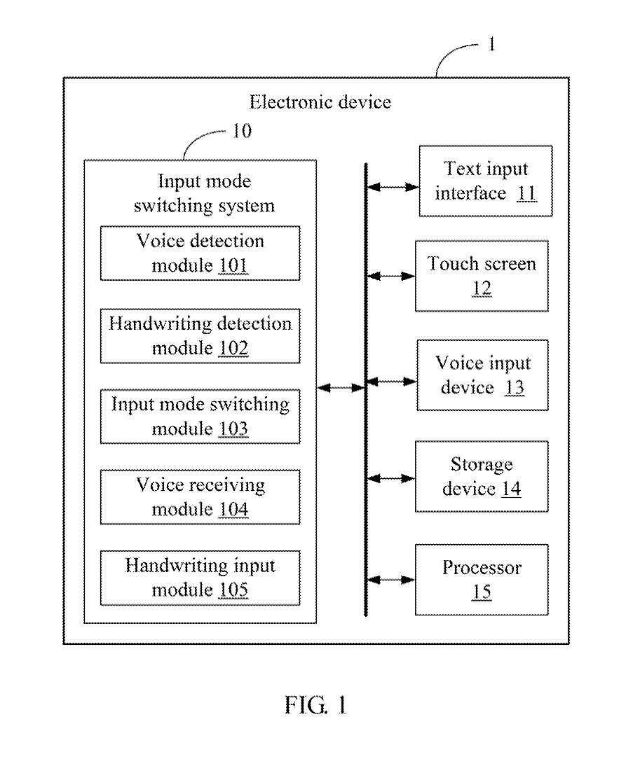

FIG. 1 is a block diagram of one example embodiment of a hardware environment for executing an input mode switching system 10. In at least one embodiment, the input mode switching system 10 is installed in and run by an electronic device 1, which can be a tablet computer, a handheld cell phone, a smart phone, a personal digital assistant (PDA), or any other portable electronic device having multiple input functions. The electronic device 1 comprises, but is not limited to, a text input interface 11, a touch screen 12, a voice input device 13, a storage device 14, and at least one processor 15. The touch screen 12, the voice input device 13 and the storage device 14 are respectively coupled to the at least one processor 15. The input mode switching system 10 can comprise computerized instructions in the form of one or more computer-readable programs which can be stored in the storage device 14 and executed by the at least one processor 15. FIG. 1 illustrates only one example of the electronic device 1, and other examples can comprise more or fewer components than those shown in the embodiment, or have a different configuration of the various components.

The text input interface 11 is displayed on the touch screen 12, and displays text information when a user inputs the text information to the electronic device 1 by performing a voice input operation on the voice input device 13 or a handwriting operation on the touch screen 12. The touch screen 12 receives the handwriting operation when the user uses a finger or a stylus on the touch screen 12. The voice input device 13 receives voice signals when the voice input operation is performed on the voice input device 13. In at least one embodiment, the user can input the text information to the text input interface 11 by performing the handwriting operations on the touch screen 12. In other embodiments, the user can input the text information to the text input interface 11 using a keyboard, a keypad, or a mouse of the electronic device 1. The user can speak to the voice input device 13 to perform the voice input operation. The voice input device 13 may be a speaker, a microphone, or the like.

The storage device 14 may be a non-transitory computer-readable storage medium or other non-transitory computer-readable storage systems. In at least one embodiment, the storage device 14 may be an internal storage system, such as a flash memory, a random access memory (RAM) for temporary storage of information, and/or a read only memory (ROM) for permanent storage of information. The storage device 14 may also be an external storage system, such as an external hard disk, a storage card, or a data storage medium. The at least one processor 15 executes one or more computerized codes and other applications of the electronic device 1 to provide functions of the input mode switching system 10. The at least one processor 15 is a central processing unit (CPU) or microprocessor that performs various functions of the electronic device 1.

The input mode switching system 10 can detect an input mode currently used by the electronic device 1 when the text input interface 11 is activated by the electronic device, and can automatically switch the input mode between a handwriting input mode and a voice input mode of the electronic device 1. For example, the input mode switching system 10 can switch the handwriting input mode to the voice input mode when the user performs voice input operations on the voice input device 13, and can switch the voice input mode to the handwriting mode when the user uses a finger or a stylus to perform handwriting operations on the touch screen 12.

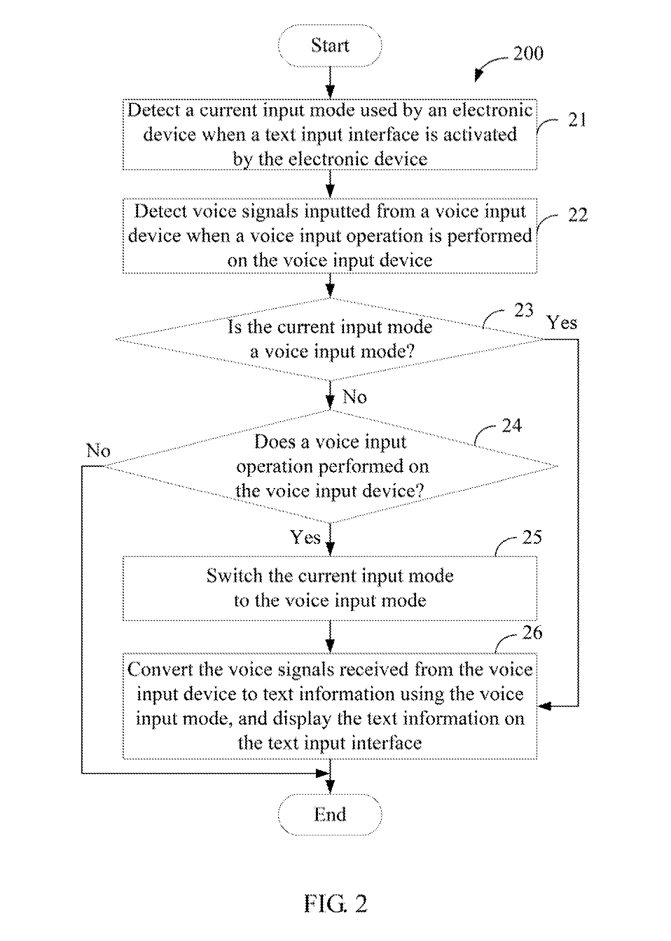

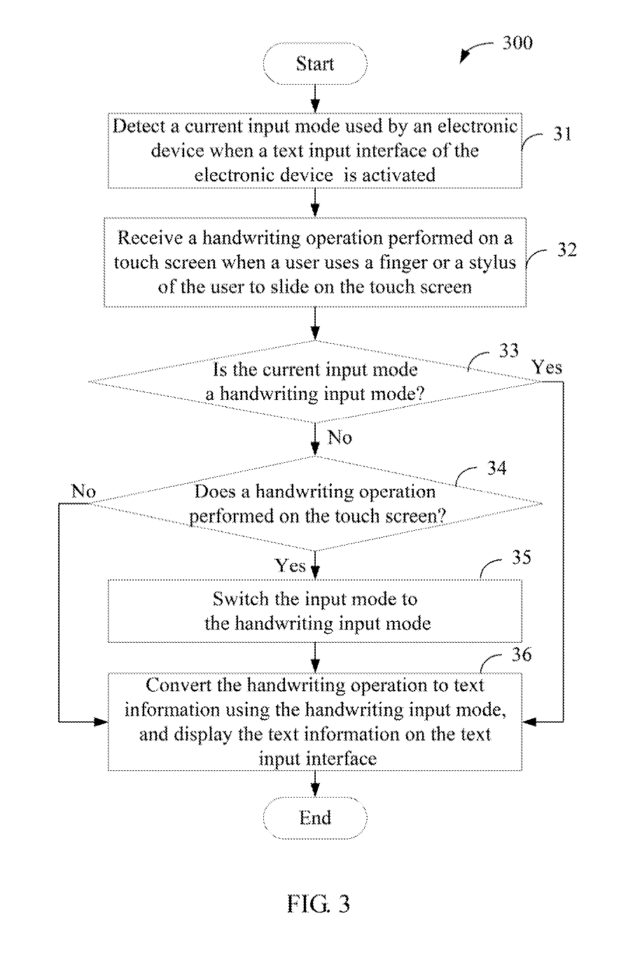

In the embodiment, the input mode switching system 10 includes, but is not limited to, a voice detection module 101, a handwriting detection module 102, an input mode switching module 103, a voice receiving module 104, and a handwriting input module 105. The modules 101-105 may comprise computerized instructions in the form of one or more computer-readable programs that are stored in a non-transitory computer-readable medium (such as the storage device 14) and executed by the at least one processor 15. The modules 101-105 can include computerized instructions to execute the method as described below and in relation to FIG. 2 and FIG. 3.

FIG. 2 illustrates a flowchart of an example embodiment of a method for automatically switching a current input mode to a voice input mode when a voice input operation is performed on an electronic device. In the example embodiment, the method 200 is performed by execution of computer-readable software program codes or instructions carried out by at least one processor of the electronic device 1 of FIG. 1.

Referring to FIG. 2, a flowchart is presented in accordance with an example embodiment. In the embodiment, the example method 200 is provided by way of example only as there are a variety of ways to carry out the method. The method 200 described below can be carried out using the configurations illustrated in FIG. 1, for example, and various elements of the figure are referenced in explaining the example method 200. Each block shown in FIG. 2 represents one or more processes, methods, or subroutines, carried out in the exemplary method 200. Furthermore, the illustrated order of blocks is by example only and the order of the blocks according to the present disclosure can be changed. Additional blocks may be added or fewer blocks may be utilized, without departing from this disclosure. The exemplary method 200 can begin at block 21.

At block 21, the voice detection module 101 (as shown in FIG. 1) detects a current input mode used by the electronic device 1 when the text input interface 11 is activated by the electronic device 1. In at least one embodiment, the input mode of the electronic device 1 can be a handwriting mode or a voice input mode. The electronic device 1 receives handwriting operations from the touch screen 12 when the handwriting mode is invoked, and receives a voice signals from the voice input device 13 when the voice input mode is invoked.

At block 22, the voice detection module 101 receives voice signals input from the voice input device 13 when the voice input operation is performed on the voice input device 13. In at least one embodiment, the voice input device 13 receives the voice signals when the user speaks to the voice input device 13.

At block 23, the voice detection module 101 determines whether the current input mode is a voice input mode. If the current input mode is not a voice input mode, block 24 is implemented. If the current input mode is a voice input mode, block 26 is implemented.

At block 24, the voice detection module 101 detects whether the voice input device 13 receives a voice input operation according to a speech to text method. In at least one embodiment, the speech to text method is used to identify the voice input operation performed on the voice input device 13. If the voice input device 13 receives a voice input operation, block 25 is implemented. If the voice input device 13 does not receive a voice input operation, the process ends.

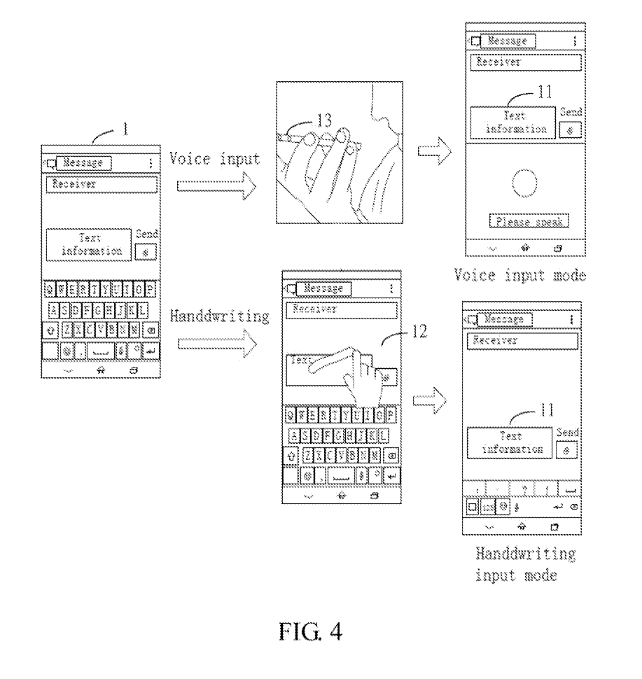

At block 25, the input mode switching module 103 switches the current input mode to the voice input mode for processing the voice input operation on the voice input device 13. In one example with respect to FIG. 4, if the current input mode used by the electronic device 1 is a handwriting input mode, the input mode switching module 103 automatically switches the handwriting input mode to the voice input mode for processing the voice input operation on the voice input device 13.

At block 26, the voice receiving module 104 converts the input voice signals received from the voice input device 13 to text information using the voice input mode, and displays the text information on the text input interface 11. As such, the electronic device 1 can accomplish the voice input operation from the voice input device 13.

FIG. 3 illustrates a flowchart of an example embodiment of a method for automatically switching a current input mode of the electronic device to a handwriting input mode when a handwriting operation is performed on the touch screen. In the example embodiment, the method 300 is performed by execution of computer-readable software program codes or instructions carried out by at least one processor of the electronic device 1 of FIG. 1.

Referring to FIG. 3, a flowchart is presented in accordance with an example embodiment. In the embodiment, the example method 300 is provided by way of example only as there are a variety of ways to carry out the method. The method 300 described below can be carried out using the configurations illustrated in FIG. 1, for example, and various elements of the figure are referenced in explaining the example method 300. Each block shown in FIG. 3 represents one or more processes, methods, or subroutines, carried out in the exemplary method 300. Furthermore, the illustrated order of blocks is by example only and the order of the blocks according to the present disclosure can be changed. Additional blocks may be added or fewer blocks may be utilized, without departing from this disclosure. The exemplary method 300 can begin at block 31.

At block 31, the handwriting detection module 102 (as shown in FIG. 1) detects a current input mode used by the electronic device 1 when the text input interface 11 is activated by the electronic device 1.

At block 32, the handwriting detection module 102 receives a handwriting operation performed on the touch screen 12 when the touch screen 12 is touched by a finger or a stylus of the user. In at least one embodiment, the handwriting operation is performed on the touch screen 12 when the user uses a finger or a stylus on the touch screen 12.

At block 33, the handwriting detection module 102 determines whether the current input mode is a handwriting input mode. If the current input mode is not a handwriting input mode, block 34 is implemented. If the current input mode is a handwriting input mode, block 36 is implemented.

At block 34, the handwriting detection module 102 detects whether the touch screen 12 receives a handwriting operation according to a handwriting identifying method. In at least one embodiment, the handwriting identifying method is used to identify the handwriting operation performed on the touch screen 12. If the touch screen 12 receives a handwriting operation, block 35 is implemented. If the touch screen 12 does not receive a handwriting operation, the process ends.

At block 35, the input mode switching module 103 switches the current input mode to the handwriting input mode for processing the handwriting operation on the touch screen 12. In one example with respect to FIG. 4, if the current input mode used by the electronic device 1 is a handwriting input mode, the input mode switching module 103 automatically switches the voice input mode to the handwriting input mode for processing the handwriting operation on the touch screen 12.

At block 36, the handwriting input module 105 converts the handwriting operation to text information using the handwriting input mode, and displays the text information on the text input interface 11. As such, the electronic device 1 can display the handwriting operation on the touch screen 12.

FIG. 4 is a diagram illustrating one embodiment of automatically switching an current input mode of the electronic device 1 between a handwriting input mode and a voice input mode. When a user speaks to the voice input device 13, the current input mode of the electronic device 1 is automatically switched to the voice input mode for processing the voice signals input from the voice input device 13. Then the input voice signals are converted to text information based on the voice input mode, and the text input interface 11 displays the text information to the user. When the user uses a finger or a stylus to slide on the touch screen 12, the current input mode of the electronic device 1 is automatically switched to the handwriting mode for processing a handwriting input on touch screen 12. Then the handwriting input is converted to text information based on the handwriting input mode, and the text information are displayed on the text input interface 11.

All of the processes described above may be embodied in, and fully automated via, functional code modules executed by one or more general purpose processors of computing devices. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size, and arrangement of parts within the principles of the present disclosure, up to and including the full extent established by the broad general meaning of the terms used in the claims.

What is claimed is:

1. An electronic device comprising:
at least one processor;
a touch screen and a voice input device both coupled to the at least one processor;
a text input interface displayed on the touch screen; and
a storage device storing a computer-readable program comprising instructions that, when executed by the at least one processor, causes the at least one processor to performing operations comprising:
detecting a current input mode used by the electronic device when the text input interface is activated by the electronic device;
switching the current input mode to a voice input mode for processing a voice input operation when the voice input operation is performed on the voice input device; and
switching the current input mode to a handwriting mode for processing a handwriting operation when the handwriting operation is performed on the touch screen.

2. The electronic device according to claim 1, wherein the current input mode is switched to the voice input mode by performing operations comprising:
receiving voice signals inputted from the voice input device;
determining whether the current input mode is the voice input mode;
switching the current input mode to the voice input mode if the current input mode is not the voice input mode;
converting the input the voice signals received from the voice input device to text information using the voice input mode; and
displaying the text information on the text input interface.

3. The electronic device according to claim 1, wherein the computer-readable program further causes the at least one processor to detect whether the voice input device receives the voice input operation using a speech to text method, and wherein the speech to text method identifies the voice input operation performed on the voice input device.

4. The electronic device according to claim 1, wherein the current input mode is switched to the handwriting mode by performing operations comprising:
receiving a handwriting operation performed on the touch screen when the touch screen is touched by a finger or a stylus of a user;
determining whether the current input mode is the handwriting input mode;
switching the current input mode to the handwriting input mode if the current input mode is not the handwriting input mode;
converting the handwriting operation to text information using the handwriting input mode; and
displaying the text information on the text input device.

5. The electronic device according to claim 1, wherein the computer-readable program further causes the at least one processor to detects whether the touch screen receives a handwriting operation according to a handwriting identifying method, and wherein the handwriting identifying method identifies the handwriting operation performed on the touch screen.

6. A method for automatically switching input modes of an electronic device, the method comprising:
detecting a current input mode used by the electronic device when a text input interface of the electronic device is activated;
switching the current input mode to a voice input mode for processing a voice input operation when the voice input operation is performed on a voice input device of the electronic device; and
switching the current input mode to a handwriting mode for processing a handwriting operation when the handwriting operation is performed on a touch screen of the electronic device.

7. The method according to claim 6, wherein the current input mode is switched to the voice input mode by performing operations comprising:
receiving voice signals inputted from the voice input device;
determining whether the current input mode is the voice input mode;
switching the current input mode to the voice input mode if the current input mode is not the voice input mode;
converting the input the voice signals received from the voice input device to text information using the voice input mode; and
displaying the text information on the text input interface.

8. The method according to claim 6, further comprising:
detecting whether the voice input device receives the voice input operation using a speech to text method, wherein the speech to text method identifies the voice input operation performed on the voice input device.

9. The method according to claim 6, wherein the current input mode is switched to the handwriting mode by performing operations comprising:
receiving a handwriting operation performed on the touch screen when the touch screen is touched by a finger or a stylus of a user;
determining whether the current input mode is the handwriting input mode;
switching the current input mode to the handwriting input mode if the current input mode is not the handwriting input mode;
converting the handwriting operation to text information using the handwriting input mode; and
displaying the text information on the text input device.

10. The method according to claim 6, further comprising:
detecting whether the touch screen receives a handwriting operation according to a handwriting identifying method, wherein the handwriting identifying method identifies the handwriting operation performed on the touch screen.

11. A non-transitory computer-readable storage medium having stored thereon instructions that, when executed by at least one processor of an electronic device, causes the least one processor to execute a method for automatically switching input modes of the electronic device, the method comprising:
detecting a current input mode used by the electronic device when a text input interface of the electronic device is activated;
switching the current input mode to a voice input mode for processing a voice input operation when the voice input operation is performed on a voice input device of the electronic device; and
switching the current input mode to a handwriting mode for processing a handwriting operation when the handwriting operation is performed on a touch screen of the electronic device.

12. The non-transitory computer-readable storage medium according to claim 11, wherein the current input mode is switched to the voice input mode by performing operations comprising:
receiving voice signals inputted from the voice input device;
determining whether the current input mode is the voice input mode;
switching the current input mode to the voice input mode if the current input mode is not the voice input mode;
converting the input the voice signals received from the voice input device to text information using the voice input mode; and
displaying the text information on the text input interface.

13. The non-transitory computer-readable storage medium according to claim 11, wherein the method further comprises:
detecting whether the voice input device receives the voice input operation using a speech to text method, wherein the speech to text method identifies the voice input operation performed on the voice input device.

14. The non-transitory computer-readable storage medium according to claim 11, wherein the current input mode is switched to the handwriting mode by performing operations comprising:
receiving a handwriting operation performed on the touch screen when the touch screen is touched by a finger or a stylus of a user;
determining whether the current input mode is the handwriting input mode;
switching the current input mode to the handwriting input mode if the current input mode is not the handwriting input mode;
converting the handwriting operation to text information using the handwriting input mode; and
displaying the text information on the text input device.

15. The non-transitory computer-readable storage medium according to claim 11, wherein the method further comprises:
detecting whether the touch screen receives a handwriting operation according to a handwriting identifying method, wherein the handwriting identifying method identifies the handwriting operation performed on the touch screen.
